(19) United States
(12) Patent Application Publication
(10) Pub. No.: US 2010/0208675 A1
(43) Pub. Date: Aug. 19, 2010

(54) APPARATUS AND METHOD FOR CONTROLLING DOWNLINK POWER IN A WIRELESS COMMUNICATION SYSTEM

(75) Inventors: Kuk-Jin Song, Gyeonggi-do (KR); Jae-Hyun Ahn, Seoul (KR)

Correspondence Address: AMPACC Law Group, 3500 188th Street S.W., Suite 103, Lynnwood, WA, 98037, US

(73) Assignee: Posco ICT Co., Ltd., Pohang (KR)

(21) Appl. No.: 12/679,009

(22) PCT Filed: Sep. 22, 2008
(86) PCT No.: PCT/KR08/05632

§ 371 Date: Mar. 18, 2010

(30) Foreign Application Priority Data
Sep. 21, 2007 (KR) 10-2007-0096324

(51) Int. Cl. H04W 52/04

(52) U.S. Cl. 370/329

(57) ABSTRACT

An apparatus and method is provided for controlling power allocated to a burst of a downlink frame that a Base Station (BS) will transmit to a Mobile Station (MS) in a wireless communication system. The power control method includes comparing a measured Carrier to Interference and Noise Ratio (CINR) of the burst with a reference CINR of the burst, calculating a difference therebetween as a boosting power if the measured CINR is lower than the reference CINR, and calculating the difference as a deboosting power if the measured CINR is higher than the reference CINR; and setting a boosting power level so that a total boosting power including the boosting power or the deboosting power is set within a power range where a possible boosting range and a possible dynamic range cross each other.

### TECHNICAL FIELD

The present invention relates generally to downlink power control, and in particular, to an apparatus and method for controlling power allocated to bursts of a downlink frame that a Base Station (BS) will transmit to a Mobile Station (MS) in a wireless communication system.

### BACKGROUND ART

Frequency bands in the wireless communication system are resources, a methodology for efficiently allocating the limited frequency band to users is multiple access, and a methodology for distinguishing connections of an uplink and a downlink in interactive communication is duplexing. The wireless multiple access and duplexing scheme is a platform technology, which is the most basis of a wireless transmission technology for efficiently using the limited frequency resources, and this scheme is determined according to the allocated frequency band, the number of users, data rate, mobility, cell configuration, wireless environment, etc.

Orthogonal Frequency Division Multiplexing (OFDM), one of such wireless transmission schemes, is a kind of a Multi-Carrier Transmission/Modulation (MCM) scheme that uses multiple carriers, and the OFDM scheme parallel-converts serial input data into parallel data, the number of which is equal to the number of the carriers used, and transmits the parallel data on the carriers individually. OFDM can be classified into OFDM-Frequency Division Multiple Access (FDMA), OFDM-Time Division Multiple Access (TDMA), and OFDM-Code Division Multiple Access (CDMA) according to the user's multiple access scheme.

Among others, OFDM-FDMA (OFDMA), a scheme suitable for the 4^{th} generation macro/micro cellular infrastructure, has no intra-cell interference and is high in frequency reuse efficiency and superior in adaptive modulation. In order to make up for the defects of OFDMA, a distributed frequency hopping technique, a multi-antenna technique and a powerful coding technique can be used to increase diversity and reduce an influence of inter-cell interference. In particular, since the OFDMA scheme is suitable for the case where many subcarriers are used, it is efficiently applied to the wireless communication system having a cell of a broad area where time delay spread is relatively high.

FIG. 1 is a diagram illustrating a method in which an MS and a BS transmit and receive data using the conventional downlink power distribution scheme.

Referring to FIG. 1, a BS, also known as a Radio Access Controller (RAS), needs to determine transmission power for each MS to transmit and receive data to/from MSs in its service coverage. The BS transmits a data frame with a preamble and/or pilot to the MS (Step S110), and the MS measures downlink quality information from the transmitted preamble and/or pilot (Step S120). Regarding the downlink quality information, or a Carrier to Interference and Noise Ratio (CINR), the MS reports downlink quality information of each band to the BS over an uplink channel (Step S130). In this case, for the entire band that the BS uses, the MS reports downlink quality information of each channel every frame.

The BS determines transmission power according to each frequency band using the downlink quality information reported from the MS (Step S140). For example, the BS can differently determine transmission power of an MS corresponding to a first band (or Frequency Allocation 1) FA1, transmission power of an MS corresponding to a second band FA2, and transmission power of an MS corresponding to a third band FA3. The bands FA1, FA2 and FA3 can each be distinguished by several subchannels.

The BS schedules power allocated for each burst of a corresponding frame according to the transmission power determined for each band, and transmits the scheduling result to the corresponding MS (Steps S150-S160). In this case, based on the transmission power determined for each band, the BS performs scheduling on a downlink frame for power allocation in units of predetermined periods (e.g., preamble periods or Partial Usage of Sub-Channel (PUSC) subchannel periods), and then performs power control (i.e., boosting or deboosting) on the bursts allocated in the downlink frame.

In this context, IEEE 802.16d/e specifies only the need for controlling downlink power for each data burst according to power boosting rules, but does not specify the detailed power control scheme. The power boosting rules are defined as follows:

1) Maximum boosting in data subcarrier per tone transmission power is 9 dB;

2) Maximum boosting per OFDMA symbol transmission power in Space-Time Coding (STC) zone is variable according to maximum allowable subcarriers;

3) Boosting step (or distribution power unit) is 3 dB; and

4) Boosting range is −12 dB˜9 dB.

In addition, IEEE 802.16d/e separately specifies zone boosting and subchannel boosting (or burst boosting) as a power boosting scheme. As for the zone boosting, when all subcarriers are not used for pilot or data in a downlink frame, the zone boosting scheme additionally boosts power of unused subcarriers, adding it to power of subcarriers in use, and this scheme boosts both the data and the pilot. The subchannel boosting (or burst boosting) boots power on a subchannel-by-subchannel basis (or on a burst-by-burst basis), and this scheme boosts only the data. The subchannel-by-subchannel (or burst-by-burst) maximum boosting range should not exceed 9 dB. By doing so, IEEE 802.16d/e can increase utilization of downlink resources.

However, a signal power-boosted in a BS may increase interference to other BSs, causing a reduction in coverage. Therefore, downlink power control in the BS should be carefully achieved, so there is a demand for a study of the detailed downlink power control based on the power boosting rules.

### DISCLOSURE OF INVENTION

### Technical Problem

Therefore, the present invention has been made in view of the above-mentioned problems, and it is an object of the present invention to provide an apparatus and method for controlling power allocated to bursts of a downlink frame so as to efficiently consume power while extending coverage of a BS and reducing inter-cell interference in a wireless communication system.

It is another object of the present invention to provide an apparatus and method for controlling power allocated to bursts of a downlink frame by a BS taking into account a CINR reported from an MS in a wireless communication system.

It is further another object of the present invention to provide an apparatus and method for controlling power allocated to bursts of a downlink frame by a BS taking into account a CINR reported from an MS and a Packet Error Rate (PER) of data bursts in a wireless communication system.

It is further another object of the present invention to provide an apparatus and method for controlling power allocated to bursts of a downlink frame by a BS taking into account a CINR reported from an MS, a packet error rate of data bursts, and a Radio Frequency (RF) transmission power range of the BS in a wireless communication system.

### Technical Solution

According to one aspect of the present invention, there is provided an apparatus for controlling power allocated to a burst of a downlink frame in a wireless communication system, the apparatus comprising: a Carrier to Interference and Noise Ratio (CINR) controller for comparing a measured CINR for the burst with a reference CINR for the burst, and calculating a boosting power or a deboosting power corresponding to a difference therebetween obtained by the comparison; and a boosting level controller for setting a boosting power level so that a total boosting power where the boosting power or the deboosting power is reflected is set within a power range where a possible boosting range and a possible dynamic range cross each other.

According to another aspect of the present invention, there is provided an apparatus for controlling power allocated to a burst of a downlink frame in a wireless communication system, the apparatus comprising: a Carrier to Interference and Noise Ratio (CINR) controller for calculating a boosting power or a deboosting power of the burst using a measured CINR; a packet error compensator for compensating the calculated boosting power or deboosting power for a power difference corresponding to a packet error of the burst; a boosting level controller for setting a boosting level corresponding to a total boosting power where the compensated boosting power or deboosting power is reflected; and a Radio Frequency (RF) range controller for controlling the burst level so that a symbol-by-symbol power of a burst allocated in the frame is set within an RF power range where a Base Station (BS) can transmit.

According to further another aspect of the present invention, there is provided a method for controlling power allocated to a burst of a downlink frame in a wireless communication system, the method comprising: (a) comparing a measured Carrier to Interference and Noise Ratio (CINR) of the burst with a reference CINR of the burst, calculating a difference therebetween as a boosting power if the measured CINR is lower than the reference CINR, and calculating the difference as a deboosting power if the measured CINR is higher than the reference CINR; and (b) setting a boosting power level so that a total boosting power including the boosting power or the deboosting power is set within a power range where a possible boosting range and a possible dynamic range cross each other.

According to further another aspect of the present invention, there is provided a method for controlling power allocated to a burst of a downlink frame in a wireless communication system, the method comprising: calculating a boosting power or a deboosting power of the burst using a measured Carrier to Interference and Noise Ratio (CINR); compensating the calculated boosting power or deboosting power for a power difference corresponding to a packet error of the burst at; setting a boosting level corresponding to a total boosting power where the compensated boosting power or deboosting power is reflected; and controlling the boosting level so that a symbol-by-symbol power of a burst allocated in the frame is set within an Radio Frequency (RF) power range where a Base Station (BS) can transmit.

### Advantageous Effects

According to the present invention, a BS can control power allocated to a burst of a downlink frame to increase efficiency of downlink resources and set a total boosting power of each burst below 9 dB, meeting the standard specification. Further, the BS can boost necessary power for the burst having a power lower than a reference CINR corresponding to the minimum MCS level, and deboost the burst having a power higher than a reference CINR corresponding to the maximum MCS level so that it may have a boosting power of a particular level, thereby expanding its coverage.

In addition, according to the present invention, the BS can compensate the power for a packet error rate increased due to a difference between a packet size and an FEC block size of the burst, ensuring correct power control and contributing to a remarkable reduction in hardware complexity in actual realization.

Further, according to the present invention, the BS can transmit a downlink frame in units of a corresponding symbol within an RF transmission power range, contributing to a decrease in inter-sector or inter-cell interference. In addition, the BS preferentially readjusts a boosting level for the lower-priority burst, making it possible to boost the lower-priority bursts.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a method in which an MS and a BS transmit and receive data using the conventional downlink power distribution scheme;

FIGS. 2 and 3 are diagrams illustrating downlink transmission power ranges available in a BS according to an embodiment of the present invention;

FIG. 4 is a diagram illustrating a structure of a BS supporting OFDMA according to an embodiment of the present invention;

FIG. 5 is a diagram illustrating a structure of a scheduler according to an embodiment of the present invention;

FIG. 6 is a diagram illustrating a structure of the packet error compensator in FIG. 5;

FIG. 7 is a diagram illustrating an example of a BLER-CINR curve;

FIG. 8 is a diagram illustrating a packet error compensation table for realizing the packet error compensator of FIG. 5;

FIG. 9 is a diagram illustrating a structure of the RF range controller in FIG. 5;

FIG. 10 is a flowchart illustrating an operation of a scheduler according to an embodiment of the present invention;

FIG. 11 is a flowchart illustrating the detailed packet error compensation process of FIGS. 10; and

FIG. 12 is a flowchart illustrating the detailed RF range check process of FIG. 10.

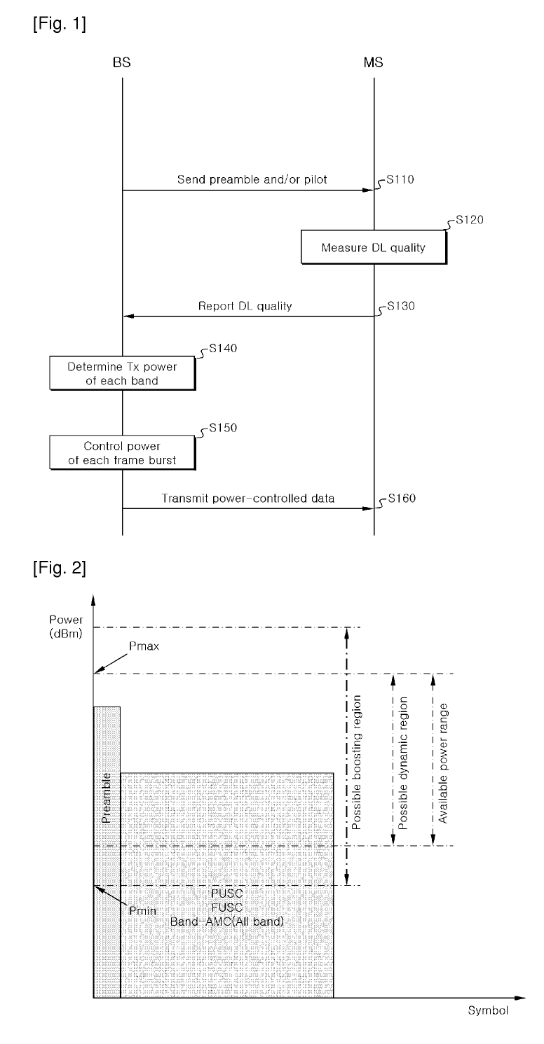

### MODE FOR THE INVENTION

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

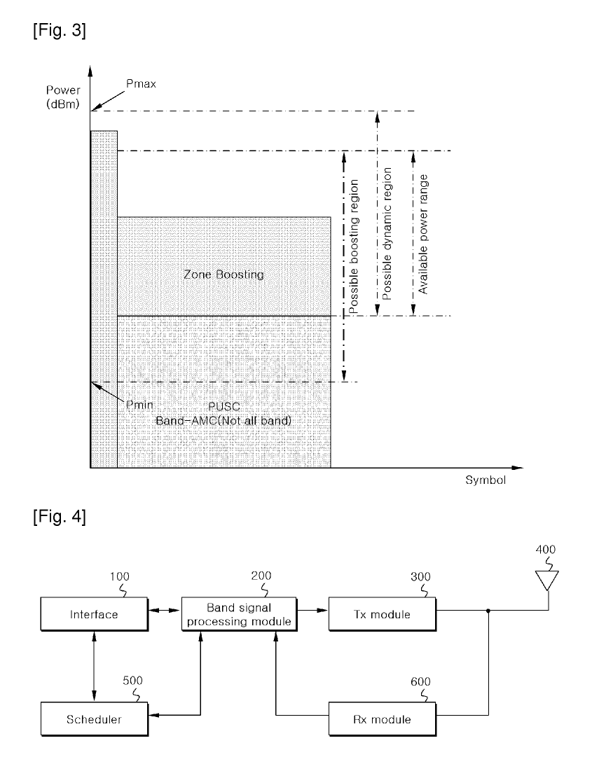

FIGS. 2 and 3 are diagrams illustrating downlink transmission power ranges available in a BS according to an embodiment of the present invention. Specifically, FIG. 2 illustrates an available downlink transmission power range for Frequency Reuse Factor (FRF)-1, and FIG. 3 illustrates an available downlink transmission power range for FRF-3.

Referring to FIGS. 2 and 3, a downlink frame in FIG. 2 includes a preamble, and can include at least one of a PUSC subchannel period, a Full Usage of Sub-Channel (FUSC) subchannel period, and a band-Adaptive Modulation and Coding (AMC) subchannel period. A downlink frame period in FIG. 3 includes a preamble, and can include at least one of a PUSC subchannel period and a band-AMC subchannel period.

In FIGS. 2 and 3, the minimum power P_{MIN} is power used when only the pilots are transmitted, and the maximum power P_{MAX} corresponds to the maximum power designed by a BS. In addition, the possible boosting range, the maximum range necessary for satisfying a boosting condition of all data subcarriers, is a boosting range specified by IEEE 802.16d/e. In addition, a possible dynamic range, the maximum range actually designed by the BS, is set between the minimum power P_{MIN} and the maximum power P_{MAX}. The possible dynamic range can be situated within the possible boosting range as shown in FIG. 2, or can get out of the possible boosting range as shown in FIG. 3.

The present invention defines, as a power range applicable in a Radio Frequency (RF) range check procedure, an available power range where two ranges (i.e., a possible boosting range and a possible dynamic range) are both applicable (intersection relation).

A description will now be made of an apparatus and method for controlling power allocated to bursts of a downlink frame by a BS in a wireless communication system according to an embodiment of the present invention.

FIG. 4 is a diagram illustrating a structure of a BS supporting OFDMA according to an embodiment of the present invention.

As illustrated in FIG. 4, the BS includes an interface 100, a band signal processing module 200, a transmission module 300, a reception module 600, a scheduler 500, and an antenna 400. The BS can be divided into a reception path and a transmission path for supporting Time Division Duplex (TDD).

In the reception path, the reception module 600 receives more than one radio signals that MSs transmit, via the antenna 400, and converts the received radio signals into a baseband signal. For example, for data reception of the BS, the reception module 600 removes noises from the signal, amplifies the noise-removed signal, down-converts the amplified signal into a baseband signal, and digitalizes the down-converted baseband signal. The band signal processing module 200 extracts information or data bits from the digitalized signal, and performs demodulation, decoding and error correction processes thereon. The received information is delivered to an adjacent wire/wireless network via the interface 100, or transmitted back to other MSs being serviced by the BS, through the transmission path.

In the transmission path, the interface 100 receives voice, data, and/or control information from a base station controller or a radio network, and the band signal processing module 200 encodes the voice, data, and/or control information, and outputs the result to the transmission module 300. The transmission module 300 modulates the encoded voice, data, and/or control information with a carrier signal having a desired transmission frequency or frequencies, amplifies the modulated carrier signal to a level suitable for transmission, and transmits the amplified carrier signal over the air via the antenna 400.

The scheduler 500 controls operations and elements of the reception path and the transmission path. Particularly, according to the present invention, in the transmission path, the scheduler 500 configures a frame to be transmitted to MSs, maps corresponding bursts thereto, allocates transmission power for each burst, and performs burst-by-burst power control based thereon. With reference to the accompanying drawing, a detailed description will now be made of the scheduler.

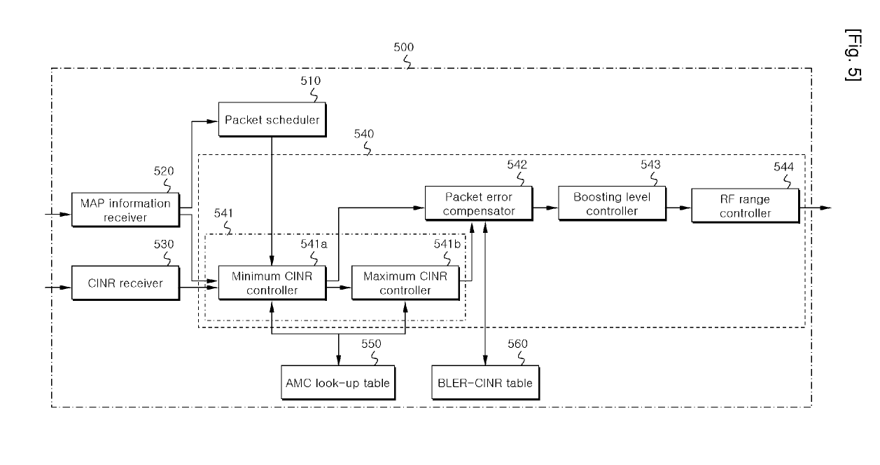

FIG. 5 is a diagram illustrating a structure of a scheduler according to an embodiment of the present invention.

As illustrated in FIG. 5, the scheduler 500 includes a packet scheduler 510, a MAP information receiver 520, a CINR receiver 530, a power control scheduler 540, and an AMC look-up table 550, and the power control scheduler 540 includes a CINR controller 541, a packet error compensator 542, a boosting level controller 543, and an RF range controller 544.

The packet scheduler 510 determines a size of packets, allocates packets to bursts using various packet scheduling algorithms (e.g., Round Robin scheme and PR scheme) based on burst allocation information, and determines priority of bursts based on the burst allocation information. The size of packets is variable, and the packet scheduler 510 determines a size of packets based on a Downlink Interval Usage Code (DIUC) from Burst Profile Management (BPM) (including modulation scheme, Forward Error Correction (FEC) scheme, preamble length, guard interval, etc.). For example, in BPM, AMC determines DIUC that satisfies an FEC Block Error Rate (BLER) of 1%.

The MAP information receiver 520 receives burst allocation information through a downlink MAP. The burst allocation information is written in a downlink MAP Information Element (IE), and includes therein Connection Identifier (CID) information, CINR information, and size information and location information of packets allocated to bursts.

The CINR receiver 530, whenever requested by the power control scheduler 540, measures a corresponding CINR from an MS, and provides the measured CINR to the power control scheduler 540. The CINR measurement is achieved through a Channel Quality Information (CQI) channel of an uplink, and the CINR receiver 530 receives a CINR estimate.

The power control scheduler 540 calculates a boosting power or deboosting power corresponding to a difference between a measured CINR and a reference CINR for obtaining a predetermined block error rate (e.g., 1%) for a burst having a particular Modulation and Coding Scheme (MCS) level, calculates a boosting power for packet error rate compensation at an MCS level allocated to an additionally given burst, determines a boosting power level of the corresponding burst by checking if the total boosting power calculated using the calculated boosting or deboosting power and the boosting power calculated for packet error rate compensation is less than a threshold power level (e.g., 9 dB) suggested by the standard, and then checks if the boosted burst—the boosting power level is set in units of a distribution power (e.g., 3 dB), or boosting step, within the standard range—is suitable for a power amplifier (not shown) or FRF that the BS actually employs. A detailed description of the power control scheduler 540 will be given below.

The AMC look-up table 550, to reduce complexity of the design, stores a reference CINR for AMC of bursts allocated in a frame, so that the power control scheduler 540 can make reference to a reference CINR corresponding to a particular MCS level.

Meanwhile, the power control scheduler 540 includes the CINR controller 541 having a minimum CINR controller 541a and a maximum CINR controller 541b, the packet error compensator 542, the boosting level controller 543, and the RF range controller 544.

The minimum CINR controller 541a compares a CINR of a given burst with a CINR (i.e., reference CINR) corresponding to a particular MCS level (e.g., MCS level=Quadrature Phase Shift Keying (QPSK) ½ repetition 6), and calculates a boosting power which is a difference between the reference CINR and the received CINR if the CINR of the given burst is lower than the reference CINR. Since the CINR corresponding to each MCS level means a reference CINR, and the reference CINR means a CINR at which a burst of a particular MCS level obtains a block error rate of 1%, the reference CINR can be previously stored in the AMC look-up table 550 for simplicity of realization.

The maximum CINR controller 541b compares a CINR of a given burst with a CINR (i.e., reference CINR) corresponding to a particular MCS level (e.g., MCS level=64-ary Quadrature Amplitude Modulation (64QAM) ⅚), and calculates a deboosting power which is a difference between the reference CINR and the measured CINR if the CINR of the given burst is higher than the reference CINR.

The packet error compensator 542 calculates a boosting power so as to compensate a power corresponding to an increase in a packet size compared with an FEC block size at an MCS level allocated to a given burst. For example, the scheduler 500 determines an MCS level of a burst to be transmitted to a corresponding MS based on the reported CINR, and distributes a power so as to satisfy a 1% FEC block error rate at the determined MCS level. However, since the packet scheduler 510 determines the packet size taking both the Quality of Service (QoS) and the reported CINR into account, the scheduler 500 can occasionally determine the packet size assigned for the given burst to be greater than the FEC block size for satisfying the 1% FEC block error rate at a corresponding MCS level for the given burst. Accordingly, in some cases, the given burst cannot satisfy the 1% FEC block error rate under the distributed power. Therefore, there is a need to compensate for a packet error rate increased by the packet size which is increased as compared with the FEC block size for satisfying the 1% FEC block error rate at an MCS level of the given burst.

Specifically, a relationship between a packet error rate and a block error rate is defined as Equation (1).

P_{P}=1−(1−P_{F})^{N}^{_{P}}^{/N}^{_{F}} [Equation 1]

where P_{P} denotes a packet error rate, P_{F} denotes an FEC block error rate, N_{P} denotes a packet size, and N_{F} denotes an FEC block size. The term

(1−P_{F})^{N}^{_{P}}^{/N}^{_{F}}

means a probability that every FEC block will have no error. If a packet error rate calculated by Equation (1) is higher than a preset threshold (e.g., packet error rate corresponding to a reference CINR at a particular MCS level), since it means that the packet size is increased as compared with the FEC block size, the packet error compensator 542 calculates a boosting power of the given burst so as to compensate for the packet error rate by the increased packet size.

With the accompanying drawing, a further detailed description will now be made of a structure of the packet error compensator.

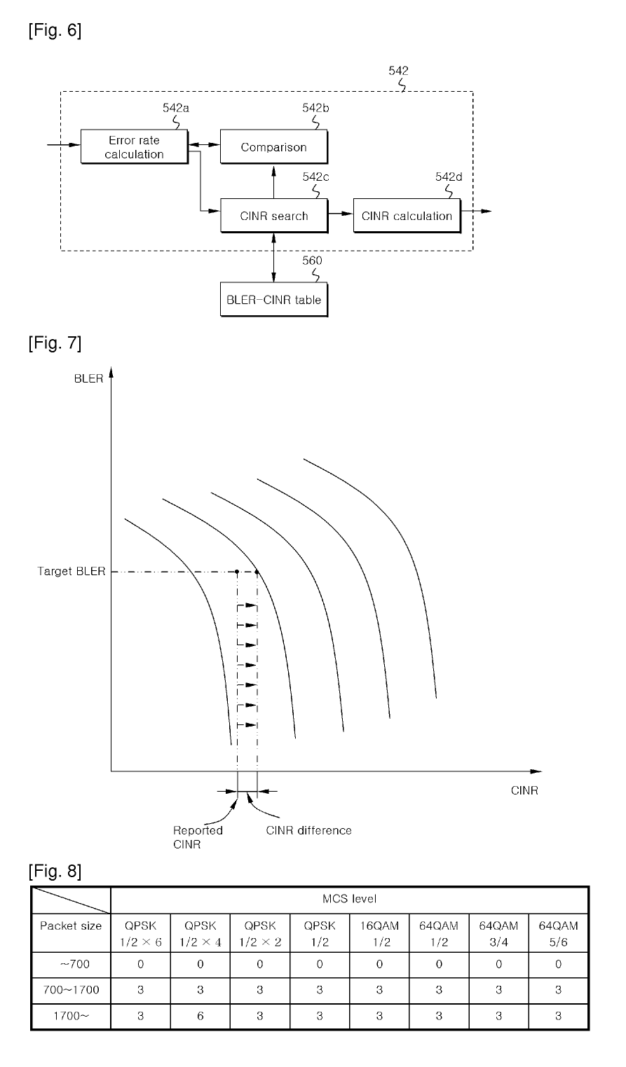

FIG. 6 is a diagram illustrating a structure of the packet error compensator in FIG. 5. In this structure, the packet error compensator performs packet error compensation on the burst which is power-boosted/deboosted in the CINR controller 541.

As illustrated in FIG. 6, the packet error compensator 542 includes an error rate calculation means 542a, a comparison means 542b, a CINR search means 542c, and a CINR calculation means 542d.

The error rate calculation means 542a calculates an FEC block error rate P_{F} and a packet error rate P_{P}. The FEC block error rate can be obtained through a BLER-CINR curve or BLER-CINR table 560, and a CINR measured from the CINR receiver 530. For example, the error rate calculation means 542a can obtain a block error rate P_{F} corresponding to the measured CINR by checking the BLER-CINR curve or BLER-CINR table 560. Accordingly, the error rate calculation means 542a can obtain a packet error rate P_{P} by applying the block error rate P_{F} to Equation (1).

The comparison means 542b compares the packet error rate P_{P} obtained by the error rate calculation means 542a with a preset threshold Pₜₕᵣ, and calculates a new FEC block error rate P_{F}′ using Equation (2) if the packet error rate P_{P} is higher than the threshold Pₜₕᵣ. However, if the packet error rate P_{P} is lower than the threshold Pₜₕᵣ as a result of the comparison, the packet error compensator 542 does not perform packet error compensation since there is no need for power boosting as it satisfies a reference CINR. The new FEC block error rate P_{F}′ represents an FEC block error rate for obtaining a preset threshold Pₜₕᵣ, and the threshold Pₜₕᵣ represents a packet error rate for keeping a reference CINR of a burst.

P_{F}′=1−(1−Pₜₕᵣ)^{N}^{_{P}}^{/N}_{P}^{_{F}} [Equation 2]

The CINR search means 542c obtains a CINR being coincident with the new FEC block error rate P_{F}′ based on the BLER-CINR curve or BLER-CINR table 560. That is, if the packet error rate P_{P} is higher than the threshold Pₜₕᵣ as a result of the comparison of the comparison means 542b, it means that as the packet error rate of the given burst is higher than the threshold Pₜₕᵣ, it is necessary to perform power boosting to make up for the shortage.

Based on the CINR obtained by the CINR search means 542c and the CINR measured from the CINR receiver 530, the CINR calculation means 542d obtains a difference therebetween using Equation (3), and outputs the difference as the total power to be boosted for the burst.

$$Δ C {INR}_{dB} = 101 {log}_{10} \{ {10}^{\frac{CINRdB}{10}} - {10}^{\frac{{CINR}_{reported , d B}}{10}} \} \qquad [ Equation 3 ]$$

where
CINR_{reported,dB} denotes a measured CINR (dB), and
CINR_{dB} denotes a CINR necessary for satisfying the new FEC block error rate P_{F}′.

FIG. 7 is a diagram illustrating an example of a BLER-CINR curve, and is given for a conceptual description of packet error compensation.

Referring to FIG. 7, a measured CINR of a burst given for a target BLER is represented by ‘reported CINR’, and a reference CINR is represented by ‘referenced CINR’. By boosting a power by a difference between both CINRs, the packet error compensator 542 can allow the given burst to achieve the target BLER corresponding to the reference CINR.

Meanwhile, in order to simply realize the packet error compensator 542 by hardware, it is possible to show boosting power levels with respect to packet sizes for a particular MCS level, as shown in FIG. 8.

FIG. 8 is a diagram illustrating a packet error compensation table for simply realizing the packet error compensator of FIG. 6, and the results were obtained through repeated experiments with the complex structure of FIG. 6 omitted.

Referring to FIG. 8, an MCS level allocated to a given burst is classified into QPSK ½ repetition 6, QPSK ½ repetition 4, . . . , 64 QAM ⅚, and a size of each packet is classified into a size of 700 or less, a size between 700 and 1700, and a size of 1700 or more. If a size of the packet is 700 or less as a result of the repeated experiments on the MCS level and the size of the packet, there is no need for CINR compensation regardless of the MCS level, and if a size of the packet ranges between 700 and 1700, it is possible to achieve the target BLER by compensating the CINR by 3 dB regardless of the MCS level. If a size of the packet is 1700 or more, it is possible to achieve the target BLER by compensating the CINR by 6 dB only for the QPSK ½ repetition 4, and compensating the CINR by 3 dB for the other MCS levels.

Referring to back to FIG. 5, after the boosting or deboosting power of a given burst is calculated by the minimum and maximum CINR controllers 541a and 541b and the packet error compensator 542, the boosting level controller 543 checks the total boosting power including a zone boosting power for the given burst, and controls its boosting power level to be suitable for the rule specified in IEEE 802.16d/e. Specifically, the boosting level controller 543 checks the total boosting power of the given burst, sets the total boosting power level of the given burst to a threshold power level if the checked total boosting power is greater than or equal to a threshold power (e.g., 9 dB), and sets the total boosting power level of the burst to a distribution power (e.g., 3 dB) if the checked total boosting power is less than or equal to the threshold power level. That is, if there was a power boosting of 4.8 dB, the boosting level controller 543 sets the boosting power level of the given burst to 6 dB.

The RF range controller 544 checks if the burst, a boosting power level of which is determined by the boosting level controller 543, is suitable for a power amplifier (not shown) or FRF that the BS actually employs.

Specifically, an OFDMA-based BS generally transmits a frame to an MS on a symbol-by-symbol basis. Accordingly, there is a need for a process of checking if the total power level of bursts, the boosting or deboosting power level of which is determined, falls within an RF transmission power range of the BS, on a symbol-by-symbol basis (or slot-by-slot basis). Since the power boosting was performed on a burst-by-burst basis previously, this process checks if the boosted power falls within the RF transmission power range of the BS, in units of symbols which are the actual transmission unit. The RF range controller performing such a function will be described in more detail with reference to the accompanying drawing.

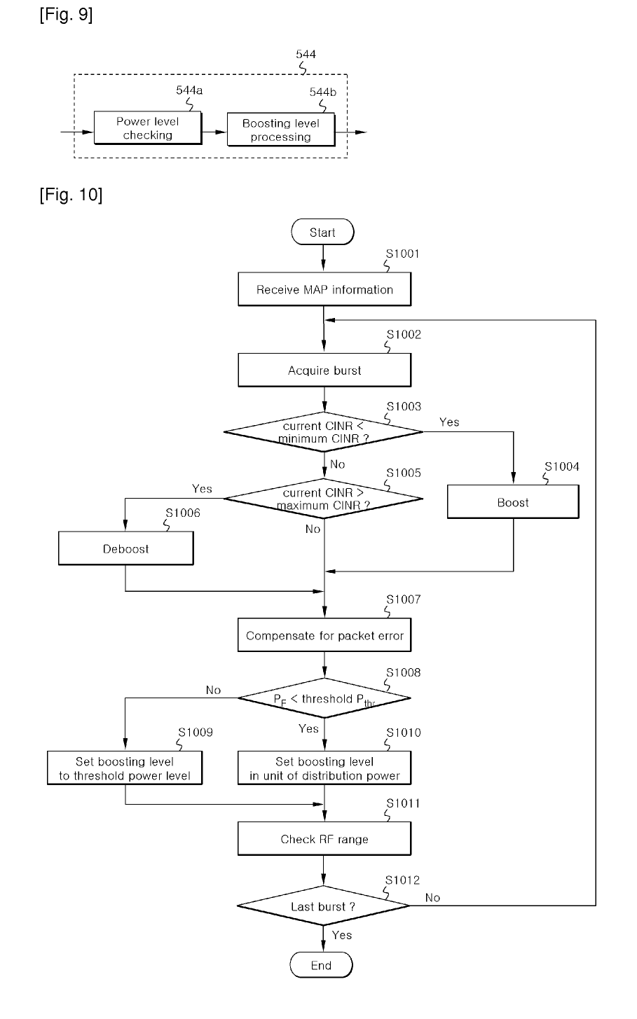

FIG. 9 is a diagram illustrating a structure of the RF range controller in FIG. 5, and is given for checking a power level of an instantaneous burst.

As illustrated in FIG. 9, the RF range controller 544 includes a power level checking means 544a and a boosting level processing means 544b.

The power level checking means 544a checks a power level for at least one burst arranged in a downlink frame at every symbol time from the start symbol to the last symbol. That is, the power level checking means 544a checks if at least one burst arranged in the frame is within the power range where the BS can transmit it on a symbol-by-symbol basis. For example, if the maximum power and the minimum power with which the BS can transmit the burst at every symbol time are defined as P_{MAX} and P_{MIN}, respectively, the power level checking means 544a checks if the power falls within a range between the maximum power and the minimum power at a particular symbol time. This check is performed by Equation (4).

$${P}_{min , dB} \leq 101 {log}_{10} {\sum }_{i}^{{N}_{burst}} {10 }^{{10}^{B {L}_{d B}}} \leq {P}_{max , dB} \qquad [ Equation 4 ]$$

where N_{burst} denotes the number of bursts transmitted at a particular symbol time, and BL_{dB} denotes a boosting power level determined in a dB scale.

The boosting level processing means 544b controls a boosting power level for a symbol time according to the check results on the power level at the symbol time by the power level checking means 544a. For example, if it is checked that the power does not fall within the range, the boosting level processing means 544b resets the boosting power or deboosting power to ‘0’, for the bursts including the symbol time.

The power control scheduler 540 can be composed of the CINR controller 541 and the boosting level controller 543, can be composed of the CINR controller 541, the packet error compensator 542 and the boosting level controller 543, or can be composed of the CINR controller 541, the boosting level controller 543 and the RF range controller 544, at the user's discretion.

With reference to FIG. 10, a description will now be made of an operation of a scheduler according to an embodiment of the present invention. Since the detailed process and operating principle thereof has been described in detail in the structure of the scheduler described in FIGS. 5 to 9, the repeated description will be omitted, and only the time procedure will be described herein in brief.

FIG. 10 is a flowchart illustrating an operation of a scheduler according to an embodiment of the present invention.

Referring to FIG. 10, the MAP information receiver 520 receives a downlink MAP to acquire burst allocation information (Step S1001). Subsequently, the CINR controller 541 acquires the highest-priority burst from a queue of the packet scheduler 510 (Step S1002).

Thereafter, the CINR controller 541 obtains a measured CINR for the highest-priority burst by means of the CINR receiver 530, and checks if the measured CINR is lower than a reference CINR corresponding to a particular MCS level (Step S1003). For example, the CINR controller 541 checks if a reference CINR with an MCS level=QPSK ½ repetition 6 corresponds to the minimum CINR and the measured CINR is lower than the minimum CINR. If it is checked that the measured CINR is lower than the minimum CINR, the CINR controller 541 calculates a boosting power corresponding to a difference between the measured CINR and the minimum CINR (Step S1004). Further, the CINR controller 541 obtains a measured CINR for the highest-priority burst by means of the CINR receiver 530, and checks if the measured CINR is greater than a reference CINR corresponding to a particular MCS level (Step S1005). For example, the CINR controller 541 checks if a reference CINR with an MCS level=64 QAM ⅚ corresponds to the maximum CINR and the measured CINR is higher than the maximum CINR. If it is checked that the measured CINR is higher than the maximum CINR, the CINR controller 541 calculates a deboosting power corresponding to a difference between the measured CINR and the maximum CINR (Step S1006).

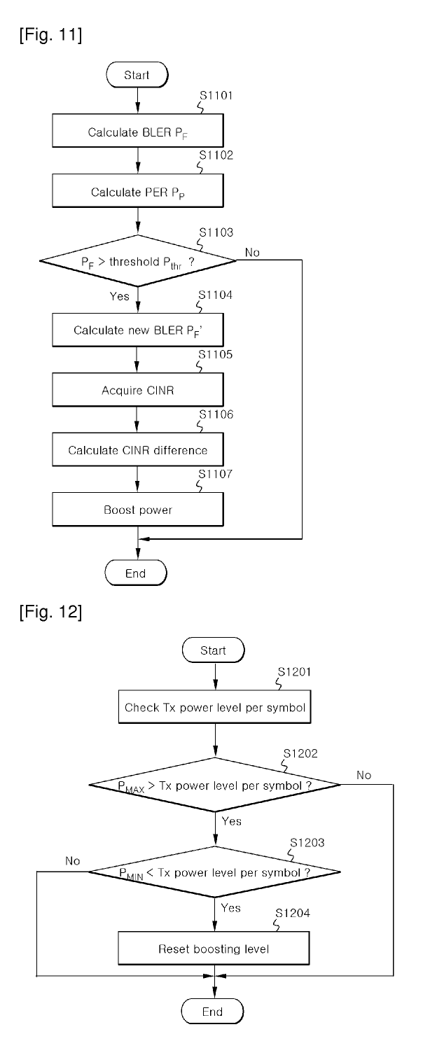

Next, the packet error compensator 542 performs a packet error compensation process on the burst, the boosting or deboosting power of which is calculated (Step S1007). The packet error compensation process will be described in more detail with reference to FIG. 11.

Thereafter, the boosting level controller 543 checks if the total boosting power including a zone boosting power is less than a threshold power level (e.g., 9 dB) for the burst, a packet error rate of which is compensated in Step S1007 (Step S1008). If it is checked that the total boosting power is less than the threshold power level, the boosting level controller 543 sets the boosting power level in units of a distribution power (Step S1010). However, if the total boosting power is greater than or equal to the threshold power level, the boosting level controller 543 sets the total boosting power of the corresponding burst to the threshold power level, following the rule of IEEE 802.16d/e (Step S1009).

The RF range controller 544 checks if the burst-by-burst determined power level falls within an RF range where the BS can transmit a burst at every symbol time, and controls the corresponding boosting power level (Step S1011). Specifically, referring to FIG. 12, the power level checking means 544a checks if the burst-by-burst determined power level falls within the RF range where the BS can transmit a burst at every symbol time (Step S1201). This check process uses Equation (4). If it is checked that the burst-by-burst determined power level falls within the RF range where the BS can transmit a burst, the boosting level processing means 544b keeps the ongoing operation. However, if the burst-by-burst determined power level gets out of the RF range, the boosting level processing means 544b resets the boosting power level of the corresponding burst (Steps S1202-S1204).

Thereafter, the RF range controller 544 checks if the current burst is the last burst (Step S1012). If the current burst is the last burst, the RF range controller 544 ends the power control process for the burst. However, if the current burst is not the last burst, the CINR controller 541 acquires the second highest-priority burst from a queue of the packet scheduler 510, and repeatedly performs Step S1003 and its succeeding steps.

FIG. 11 is a flowchart illustrating the detailed packet error compensation process of FIG. 10.

Referring to FIG. 11, the error rate calculation means 542a obtains an FEC block error rate P_{F} through the BLER-CINR curve or BLER-CINR table 560 and the CINR measured from the CINR receiver 530 (Step S1101). Further, the error rate calculation means 542a obtains a packet error rate P_{P} by applying the FEC block error rate P_{F} to Equation (1) (Step S1102).

Subsequently, the comparison means 542b compares the packet error rate P_{P} obtained by the error rate calculation means 542a with a preset threshold Pₜₕᵣ (Step S1103). If the packet error rate P_{P} is higher than the preset threshold Pₜₕᵣ, the comparison means 542b calculates a new FEC block error rate P_{F}′ using Equation (2) (Step S1104). However, if the packet error rate P_{P} is lower than the preset threshold Pₜₕᵣ as a result of the comparison, the packet error compensator 542 does not perform packet error compensation since there is no need for power boosting as it satisfies the reference CINR.

Based on the BLER-CINR curve or BLER-CINR table 560, the CINR search means 542c obtains a CINR being coincident with the new FEC block error rate P_{F}′ (Step S1105). Thereafter, based on the CINR obtained by the CINR search means 542c and the CINR measured from the CINR receiver 530, the CINR calculation means 542d obtains a difference therebetween using Equation (3) (Step S1106). Next, the CINR calculation means 542d outputs the difference as the total boosting power for a given burst (Step S1107).

By doing so, it is possible to increase efficiency of downlink resources and set the total boosting power of each burst below a threshold power level, meeting the standard specification. In addition, it is possible to expand the coverage by boosting the necessary power for the burst having a power lower than a reference CINR corresponding to the minimum MCS level, or by deboosting the burst having a power higher than a reference CINR corresponding to the maximum MCS level so that it may have a boosting power of a particular level. Further, it is possible to reduce inter-sector or inter-cell interference by transmitting the downlink frame in units of a corresponding symbol within an RF transmission power range of the BS. In addition, the boosting power level can be readjusted for the low-priority bursts, guaranteeing priority of the bursts.

While the invention has been shown and described with reference to a certain preferred embodiment thereof, it will be understood by those skilled in the art that various changes in form and details may be made therein without departing from the spirit and scope of the invention as defined by the appended claims.

1. An apparatus for controlling power allocated to a burst of a downlink frame in a wireless communication system, the apparatus comprising:
a Carrier to Interference and Noise Ratio (CINR) controller for comparing a measured CINR for the burst with a reference CINR for the burst, and calculating a boosting power or a deboosting power corresponding to a difference therebetween obtained by the comparison; and
a boosting level controller for setting a boosting power level so that a total boosting power where the boosting power or the deboosting power is reflected is set within a power range where a possible boosting range and a possible dynamic range cross each other.

2. The apparatus of claim 1, wherein the total boosting power includes a zone boosting power for the burst.

3. The apparatus of claim 1, wherein the possible boosting range is a maximum range necessary for satisfying a boosting condition of a data subcarrier, and the possible dynamic range is a maximum range designed in a Base Station (BS).

4. The apparatus of claim 1, wherein the boosting level controller sets the boosting power level to a threshold power level if the total boosting power is higher than the threshold power level, and sets the boosting power level by using a quantized power unit if the total boosting power is lower than the threshold power level.

5. The apparatus of claim 1, wherein the CINR controller comprises:
a minimum CINR controller for calculating a boosting power corresponding to the difference for the burst if the measured CINR is lower than the reference CINR as a result of the comparison; and
a maximum CINR controller for calculating a deboosting power corresponding to the difference for the burst if the measured CINR is higher than the reference CINR as a result of the comparison.

6. (canceled)

7. (canceled)

8. (canceled)

9. (canceled)

10. (canceled)

11. The apparatus of claim 1, further comprising:
a Radio Frequency (RF) range controller for controlling the set boosting power level so that a symbol-by-symbol power of a burst allocated in the frame is set within an RF power range where a BS can transmit.

12. The apparatus of claim 11, wherein the RF range controller comprises:
a power level checking means for checking if a power level falls within an available power range for a burst allocated in the frame at every symbol from a start symbol to a last symbol; and
a boosting level processing means for resetting a boosted or deboosted power for the burst if it is checked that the symbol-by-symbol power gets out of the RF power range.

13. The apparatus of claim 11, wherein the power level checking means checks the available power range using the following equation;
$${P}_{min , dB} \leq 10 {log}_{10} {\sum }_{i}^{{N}_{burst}} {10 }^{\frac{B {L}_{d B}}{10}} \leq {P}_{max , dB}$$
where Pmin,dB denotes a possible minimum power, Pmax,dB denotes a possible maximum power, Nburst denotes the number of bursts transmitted at a particular symbol time, and BLdB denotes a boosting level determined in a dB scale.

14. The apparatus of claim 1, further comprising:
an Adaptive Modulation and Coding (AMC) look-up table for storing the reference CINR at a particular Modulation and Coding Scheme (MCS) level for the burst.

15. The apparatus of claim 1, further comprising:
a packet error compensation table for storing a boosting level associated with a packet size of the burst for an MCS level allocated for the burst.

16. An apparatus for controlling power allocated to a burst of a downlink frame in a wireless communication system, the apparatus comprising:
a Carrier to Interference and Noise Ratio (CINR) controller for calculating a boosting power or a deboosting power of the burst using a measured CINR;
a packet error compensator for compensating the calculated boosting power or deboosting power for a power difference corresponding to a packet error of the burst;
a boosting level controller for setting a boosting level corresponding to a total boosting power where the compensated boosting power or deboosting power is reflected; and
a Radio Frequency (RF) range controller for controlling the burst level so that a symbol-by-symbol power of a burst allocated in the frame is set within an RF power range where a Base Station (BS) can transmit.

17. A method for controlling power allocated to a burst of a downlink frame in a wireless communication system, the method comprising:
(a) comparing a measured Carrier to Interference and Noise Ratio (CINR) of the burst with a reference CINR of the burst, calculating a difference therebetween as a boosting power if the measured CINR is lower than the reference CINR, and calculating the difference as a deboosting power if the measured CINR is higher than the reference CINR; and
(b) setting a boosting power level so that a total boosting power including the boosting power or the deboosting power is set within a power range where a possible boosting range and a possible dynamic range cross each other.

18. The method of claim 17, wherein the step (b) comprises:
setting the boosting power level to a threshold power level if the total boosting power is higher than the threshold power level, and setting the boosting power level by using a quantized power unit if the total boosting power is lower than the threshold power level.

19. The method of claim 17, wherein the total boosting power includes a zone boosting power for the burst.

20. The method of claim 17, further comprising:
compensating for a power difference derived from a difference between Forward Error Correction (FEC) block size and a packet size of the burst at the boosting power or the deboosting power.

21. The method of claim 20, further comprising:
comparing a packet error rate for the burst with a packet error rate for the reference CINR, calculating a corrected CINR using a packet size of the burst and an FEC block size of the burst if the packet error rate for the burst is higher than the packet error rate for the reference CINR, and calculating a power difference by comparing the corrected CINR with the measured CINR.

22. The method of claim 21, wherein the corrected CINR is obtained through a corrected FEC block error rate calculated using the packet error rate for the reference CINR, the block size of the burst, and the packet size of the burst.

23. The method of claim 17, further comprising:
controlling the set boosting power level so that a symbol-by-symbol power of a burst allocated in the downlink frame is set within an Radio Frequency (RF) power range where a Base Station (BS) can transmit.

24. A method for controlling power allocated to a burst of a downlink frame in a wireless communication system, the method comprising:
calculating a boosting power or a deboosting power of the burst using a measured Carrier to Interference and Noise Ratio (CINR);
compensating the calculated boosting power or deboosting power for a power difference corresponding to a packet error of the burst at;
setting a boosting level corresponding to a total boosting power where the compensated boosting power or deboosting power is reflected; and
controlling the boosting level so that a symbol-by-symbol power of a burst allocated in the frame is set within an Radio Frequency (RF) power range where a Base Station (BS) can transmit.

25. The apparatus of claim 1, further comprising:
a packet error compensator for compensating for a power difference derived from a difference between a Forward Error Correction (FEC) block size and a packet size of the burst at the boosting power or the deboosting power.

26. The apparatus of claim 25, wherein the packet error compensator calculates a second FEC block error rate if a packet error rate is higher than a threshold, and compensates for the power difference using a CINR being coincident with the second FEC block error rate.

27. The apparatus of claim 26, wherein the packet error rate is calculated using the following equation;
P_{P}=1−(1−P_{F})^{N}^{_{P}}^{/N}^{_{F}}
where PP denotes a packet error rate, PF denotes a first FEC block error rate, NP denotes a packet size of the burst, and NF denotes an FEC block size of the burst.

28. The apparatus of claim 26, wherein the second FEC block error rate is calculated using the following equation;
P_{F}′=1−(1−Pₜₕᵣ)^{N}^{_{P}}^{/N}^{_{P}}
where Pthr denotes a packet error rate for a reference CINR of the burst, Np denotes a packet size of the burst, and NF denotes an FEC block size of the burst.

29. The apparatus of claim 26, wherein the boosting power or deboosting power for compensation is calculated using the following equation;
$$Δ C {INR}_{dB} = 101 {log}_{10} \{ {10 }^{\frac{{{CINR}^{′}}_{d B}}{10}} - {10 }^{\frac{{CINR}_{reported , d B}}{10}} \}$$
where CINR_{reported,dB} denotes the measured CINR (dB), and CINR_{dB} denotes a corrected CINR.
